(19) United States
(12) Patent Application Publication
(10) Pub. No.: US 2005/0220425 A1
(43) Pub. Date: Oct. 6, 2005

(54) Optoelectronic arrangement

(76) Inventors: Jorg-Reinhard Kropp, Berlin (DE); Dipl.-Ing. Jens Fiedler, Potsdam (DE); Thomas Knuth, Berlin (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/815,046

(22) Filed: Mar. 31, 2004

(51) Int. Cl. G02B 6/42

(52) U.S. Cl. 385/88

(57) ABSTRACT

The invention relates to an optoelectronic arrangement having: a printed circuit board, which defines a first y direction parallel to the printed circuit board surface and a second z direction perpendicular to the printed circuit board surface; a first electrical contact-making region of the printed circuit board with a plurality of first contacts; a receptacle structure arranged on the printed circuit board and having a receptacle opening for receiving a pluggable optoelectronic module; a pluggable optoelectronic module; a second electrical contact-making region of the optoelectronic module with a plurality of second contacts; plug-in means for plugging the optoelectronic module into the receptacle structure in such a way that, during the plug-in operation, the module is firstly introduced into the receptacle structure in the y direction and is then lowered in the z direction in the direction of the printed circuit board. In this case, the second contacts of optoelectronic module are in electrical contact with the first contacts of the printed circuit board in the plugged-in position.

The invention relates to an optoelectronic arrangement having an optoelectronic module which can be plugged into a receptacle structure arranged on a printed circuit board. In particular, the invention relates to a specific type of pluggable fixing of an optoelectronic module in a shielding cage.

### BACKGROUND OF THE INVENTION

Optoelectronic modules are known which, for the purpose of transferring data, have at least one optoelectronic reception transducer and/or at least one electro-optical transmission transducer. The transducers are connected to an internal module printed circuit board, for example, which can be connected via a plurality of electrical contacts to an external printed circuit board, for instance a main circuit board (motherboard). The electrical contacts of the module printed circuit board can be connected to the external printed circuit board for example via a leadframe or via a plug base, for example a BGA base. Optical waveguides can be optically coupled to the transducers via an optical port of the optoelectronic module. The jargon employs the term parallel optoelectronic modules if data of a plurality of optical channels can be emitted and/or received simultaneously via the module.

It is known to solder a parallel optoelectronic module with electrical contacts directly onto an external printed circuit board. Such parallel modules are sold for example by the applicant under the designation PAROLI®. Since optoelectronic modules constitute a special design, special devices are necessary for direct soldering, with the result that production is associated with a relatively high outlay. It is also necessary to solder the module on the printed circuit board at an early stage in the course of mounting, in particular before a shielding plate is fitted on the printed circuit board.

The document 86C/573/CD dated Sep. 19, 2003 from the IEC (International Electrochemical Commission) describes a 12-channel pluggable optoelectronic module which, using a plug base that has previously being soldered onto an external printed circuit board, can be plugged onto the plug base in the z direction (perpendicular to the printed circuit board). In this case, too, it is necessary to plug the module onto the plug base at an early stage in the course of the mounting, in particular before a shielding plate is fitted. The entire assembly is then introduced into a system housing. Simple exchange of a module is not possible. There is a need for optoelectronic arrangements which enable an optoelectronic module to be fixed and electrically contact-connected on a printed circuit board in a simple manner. In this case, it should be endeavored, in particular, to be able to introduce the module into the arrangement at a late stage in the course of mounting and to exchange it—for instance for repair purposes—in a simple manner.

### SUMMARY OF THE INVENTION

The present invention provides an optoelectronic arrangement having: a printed circuit board, which defines a first y direction parallel to the printed circuit board surface and a second z direction perpendicular to the printed circuit board surface; a first electrical contact-making region of the printed circuit board with a plurality of first contacts; a receptacle structure arranged on the printed circuit board and having a receptacle opening for receiving a pluggable optoelectronic module; a pluggable optoelectronic module; a second electrical contact-making region of the optoelectronic module with a plurality of second contacts; plug-in means for plugging the optoelectronic module into the receptacle structure in such a way that, during the plug-in operation, the module is firstly introduced into the receptacle structure in the y direction and is then lowered in the z direction in the direction of the printed circuit board. In this case, the second contacts of the optoelectronic module are in electrical contact with the first contacts of the printed circuit board in the plugged-in position.

Plugging the module into the receptacle structure successively in the y and z directions in the manner according to the invention allows the module to be plugged into the receptacle structure from the open end area of the receptacle structure—and thus from outside and after the mounting of all further components. This makes it possible, in particular, for the module to be plugged into the receptacle structure from outside by a customer of the manufacturer, the open end area of the receptacle structure being accessible for example through a cutout in a backplane of a computer housing or projecting from such a cutout. It is also possible without any problems to exchange the module from outside, for instance in the event of technical faults, without further elements of the arrangement having to be demounted in the course of the exchange.

A further advantage of the solution according to the invention is that it is possible to realize a multiplicity of electrical contacts between the module and the printed circuit board despite the module being plugged via the end side of the receptacle structure (which generally has only a relatively small area opening). In this case, it is preferred for both the electrical contacts of the module and the electrical contacts of the printed circuit board to be arranged as a two-dimensional matrix. In this way, it is possible to realize a comparatively large number of electrical contacts on a small area, which is of importance particularly in the case of a parallel optical module with generally fifty more contacts.

In a preferred refinement of the invention, the plug-in means comprise a locking/unlocking mechanism formed on the module, by means of which mechanism the module can be raised or lowered in the z direction. The module preferably has a module housing with an end side, a rear side, a top side, an underside and two side walls, it being possible for at least one optical plug to be plugged into the module via the end side. The locking/unlocking mechanism preferably has a lever with two end positions that can be actuated from the end side of the module, the module being in a locked state in one end position of the lever.

In a preferred refinement, the locking/unlocking mechanism has two arms acting as a lever, which are mounted in rotatable fashion at opposite side walls of the module housing in each case in a bearing location. Preferably, (i.e. in the direction of the rear side of the module housing) the arms on the other side of the bearing location are shaped in such a way that the arms form at least two end regions at a different distance from the bearing location, one of said end regions coming into contact with the printed circuit board or the receptacle structure in one end position and the other of said end regions coming into contact with the printed circuit board or the receptacle structure in the other end position.

This is realized, in a preferred refinement, in that the arms branch at their ends in each case in Y-shaped fashion to form two sub-arms in such a way that one sub-arm comes into contact with the printed circuit board or the receptacle structure in the one end position and the other sub-arm comes into contact with the printed circuit board or the receptacle structure in the other end position. In particular, it may be provided for this purpose that one sub-arm protrudes from the underside of the module housing in one end position and the other sub-arm protrudes from the top side of the module housing in the other end position. The end regions of the two arms that are in contact with the printed circuit board or the receptacle structure in one end position ensure that the module is raised during plugging the y direction and does not drag on the printed circuit board. The end regions that are in contact with the printed circuit board or the receptacle structure in the other end position (latching position) provide an additional support and securing of the module in the receptacle structure.

The two arms can be actuated at the end side by a lever or transverse bracket, with the result that a user can raise and lower the module in a simple manner.

Generally, the locking/unlocking mechanism preferably has elements (such as for example the latching arms mentioned) which protrude from at least one outer area of the module housing in the locked state of the module. This serves for additional support and securing of the module in the receptacle structure.

Preferably, the plug-in means comprise guiding means which provide a guiding of the module in the receptacle structure during the movement of the module in the y direction. Guiding webs of the module which are guided in the receptacle structure may be involved, by way of example.

Furthermore, spring means are preferably provided, which press the plug-in module onto the printed circuit board with a spring force directed perpendicular to said printed circuit board. In this case, by way of example, the spring means are formed at the receptacle structure, for instance are integrated into or fixed to said receptacle structure. As an alternative, however, they may also be formed at the module.

For the positioning of the module in the y direction the module preferably forms first positively locking elements and the printed circuit board forms second positively locking elements, which intermesh when the module is plugged in. By way of example, the positively locking elements of the module are formed by at least two projecting pins and the positively locking elements of the printed circuit board are formed by correspondingly arranged holes.

In an advantageous refinement, moreover, a latching mechanism is provided, which impedes the modules in the plugged-in position from moving in the z direction away from the printed circuit board. The latching mechanism preferably has spring elements which latch with structures of the module during the plug-in operation after the lowering of the module in the z direction. When the module is raised in the z direction, the latching mechanism is deactivated by the locking/unlocking mechanism.

In a preferred development, some of the second contacts are formed in mechanically leading fashion, in such a way that a defined electrical contact-making order is provided during the plugging-in and during the removal of the module. When the module is lowered, the projecting contacts firstly produce an electrical connection. The predetermined contact-making order enables the module to be plugged and removed during operation with voltage present (hot pluggability) without the risk of damage to the module.

In a further development of the invention, a heat sink is additionally provided, which projects into the receptacle structure via an opening at the top side of the receptacle structure and makes large-area mechanical contact with the module in the plugged-in position. In this case, spring means are additionally preferably provided, which press the heat sink against the plugged-in module with a spring force. The spring means are preferably supported at the receptacle structure and correspondingly additionally press, in the plugged-in position of the module, the second electrical contact-making region of the module against the first electrical contact-making region of the printed circuit board. In this respect, they fulfill a dual function.

Said spring means have for example two side parts running parallel which are respectively connected to one side of the receptacle structure, and at least two spring arms that are formed in resilient fashion and connect the side parts, the spring arms partly resting on the heat sink and exerting a spring force on the heat sink in the z direction.

The receptacle structure is preferably formed by a shielding cage comprising an electrically conductive material or a shielding housing, which is preferably formed essentially in parallelepipedal fashion. In this case, the shielding cage preferably has at its underside a plurality of protruding pins via which the shielding cage is mechanically fixedly connected to the printed circuit board. In addition, the shielding cage may be electrically connected to a shielding potential of the arrangement via the protruding pins.

### BRIEF DESCRIPTION OF THE DRAWINGS

The invention is explained in more detail below using a plurality of exemplary embodiments with reference to figures, in which:

FIG. 1 shows a perspective view of the individual components of an optoelectronic arrangement with a printed circuit board, a shielding cage and a pluggable optoelectronic module in the non-assembled state;

FIG. 2 shows a perspective view of the underside of the optoelectronic module of FIG. 1,

FIG. 3a shows a cross-sectional view of the arrangement of FIG. 1 after the optoelectronic module has been introduced and latched into the shielding cage,

FIG. 3b shows a cross-sectional view of the arrangement of FIG. 1, the optoelectronic module having been introduced into the shielding cage, but not yet having been lowered and latched;

FIG. 4 shows an alternative configuration of an optoelectronic arrangement with a printed circuit board, a shielding cage and an optoelectronic module, a heat sink fixed by means of a spring device additionally being provided, and

FIG. 5 shows the arrangement of FIG. 4 in the assembled and latched state.

### DESCRIPTION OF A PLURALITY OF PREFERRED EXEMPLARY EMBODIMENTS

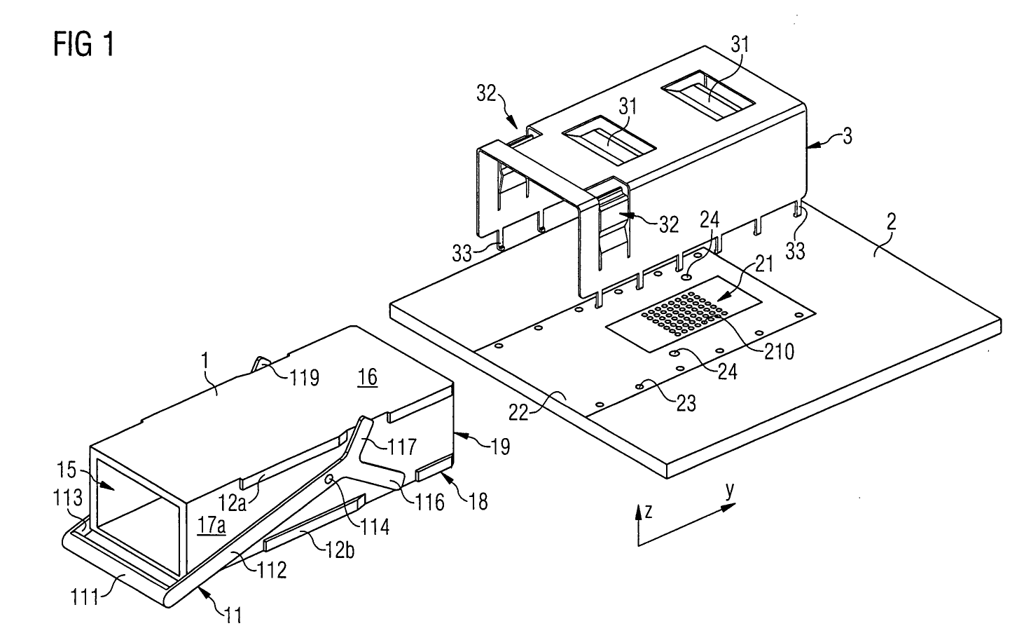

FIGS. 1 to 3b show a first exemplary embodiment of an optoelectronic arrangement with a printed circuit board 2, a shielding cage 3 fixed on the printed circuit board 2, and an optoelectronic module 1, which can be arranged in pluggable fashion on the printed circuit board 2 and in the shielding cage 3.

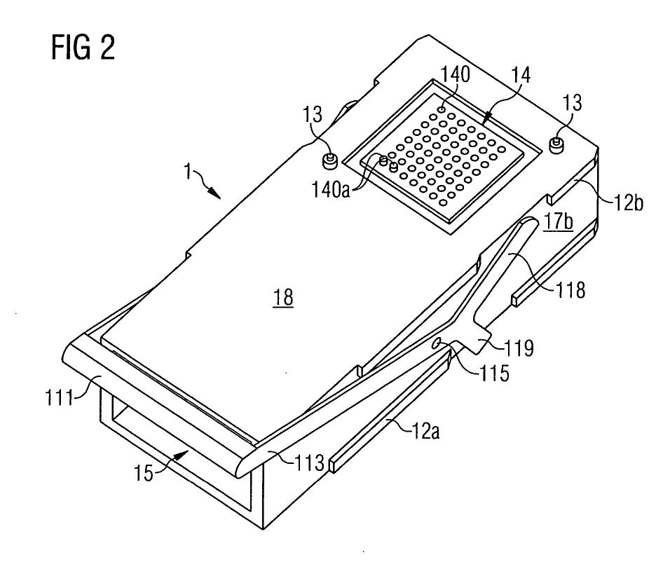

The optoelectronic module 1 has one or a plurality of optoelectronic reception transducers and/or electro-optical transmission transducers, which are connected to an internal printed circuit board of the module 1. The internal printed circuit board usually also contains electrical components such as, for example, a driver module or a preamplifier. In order to make electrical contact with the module, the latter has, as will also be explained with reference to FIG. 2, a plurality of electrical contacts which can be connected to associated contacts of a printed circuit board. Corresponding optoelectronic modules are known to the person skilled in the art, and so their construction will not be discussed in any greater detail.

The module 1 has a housing with a top side 16, an underside 18, two side walls 17a, 17b, an open end side 15 and a rear side 19. The open end side 15 serves for plugging in one or a plurality of optical plugs, via which optical signals emitted or received by the module 1 are optically coupled to one or a plurality of optical waveguides.

Upper and lower guiding webs, 12a to 12b are respectively formed at the two side walls 17a, 17b. Moreover, a locking/unlocking mechanism 11 (referred to hereinafter as unlocking mechanism) is provided at the module 1, and comprises a transverse bracket 111 arranged at the end side and two arms 112, 113 running parallel to one another. The arms 112, 113 are mounted in rotatable fashion via bearing locations 114, 115 at the respective side walls 16a, 17b of the module housing. Behind the bearing locations 114, 115, said arms branch in y-shaped fashion in each case to form two sub-arms 116, 117, 118, 119. The ends thereof are at a different distance from the respective bearing location 114, 115.

The unlocking device 11 can be pivoted back and forth between two end positions by means of the transverse bracket 111. In this case, the sub-arms 116, 117, 118, 119 of the unlocking device are configured in such a way that in each case one sub-arm projects from the underside 18 of the module housing in one end position and the other sub-arm of the module housing projects from the top side 16 of the module housing in the other end position. In the illustration in FIG. 1, the sub-arms 117, 119 in each case projects somewhat with respect to the top side 16 of the module housing.

It is pointed out that when the module housing 1 is introduced into the shielding cage 3, the transverse bracket 111 is located toward the top, that is to say is precisely in the other end position to that illustrated in FIG. 1.

FIG. 2 shows that two positioning pins 13 project from the underside 18 of the module housing. Moreover, any plug base 14 having a plurality of electrical contacts 140 arranged in a two-dimensional matrix can be seen on the underside 18. Electrical contact is made with the individual electrical and optoelectronic components of the module 1 via the electrical contacts 140. In this case, the plug base 14 or the electrical contacts 140 are preferably electrically connected to an internal printed circuit board (not illustrated) of the module 1, for instance by means of plated-through holes of the plug base 14.

In the preferred configuration, the module 1 is a parallel optoelectronic module which can simultaneously transmit and/or receive data signals on a plurality of optical channels. Accordingly, a multiplicity of electrical contacts 140 are provided. The arrangement in a two-dimensional matrix makes it possible to provide a large number of contacts on a small area.

The electrical contacts 140 are preferably formed in elastic fashion. The elastic design may be effected in many ways. In a first embodiment variant, the electrical contacts 140 are for this purpose embodied as spring contacts. In a second design, the electrical contacts 140 are formed by a conductive silicon rubber. In a third design, the elasticity of the contacts 140 is provided by a conductive, elastic metal fabric. The elasticity of the electrical contacts 140 may also be provided in a different way.

The printed circuit board 2 forms a contact-making region 21 having a multiplicity of electrical contacts 210, which are likewise arranged in the form of a two-dimensional matrix. The contacts 21 are preferably formed directly on the surface of the printed circuit board 2, for example by means of contact pads or small metallization areas. After the module 1 has been introduced into the shielding cage 3, the electrical contacts 140 of the plug base 14 of the module 1 come into electrical contact with the electrical contacts 210 of the contact-making region 21 of the printed circuit board 2. In this case, the elastic design of the contacts 140 of the plug base 14 makes it possible to compensate for unevennesses of the contact regions and to provide a reliable electrical contact.

In this case, the configuration illustrated in FIG. 1 is particularly advantageous insofar as a separate electrical plug base, with which the plug base 14 of the module 1 would then interact, is not placed on the printed circuit board 2. As a result of this, it is possible for the arrangement to be configured particularly flat. It is pointed out, however, that configurations in which the first electrical contact-making region 21 is realized on the printed circuit board 2 using a plug base soldered onto the printed circuit board are also possible, in principle. It is not necessary for this case that the electrical contacts 140 of the plug base 14 of the module 1 are formed in elastic fashion. Such a plug base arranged on the printed circuit board 2 would on the one hand provide plated-through holes to the printed circuit board 2 and on the other hand have guiding and latching structures for coupling the plug base of the module.

In a preferred configuration, some contacts 140 of the plug base 14 are formed in mechanically leading fashion, with the result that a defined electrical contact-making order is provided during the plugging-in and during the removal of the module. This enables the module 1 to be plugged during operation with voltage present (hot plugability). By way of example, in FIG. 2, two contacts 140a project somewhat with respect to the others.

A plurality of holes 23, 24 are formed in the printed circuit board 2. First of all, two holes 24 are involved, formed symmetrically with regard to the first contact-making region 21 in the printed circuit board 2. They serve to receive the positioning pins 13 of the module 1. It may be provided in this case that the positioning pins 13 converge conically downwardly.

Moreover, a multiplicity of holes 23 are provided, which serve to receive pins 33 protruding from the underside of the shielding cage 3. The pins 33 are fixedly connected to the printed circuit board 2, for example by upsetting the pins on the rear side of the printed circuit board, by special shaping of the pins to form barbs for example (so that, after the pins 33 have been pressed into the holes 23, they are prevented from withdrawing), or by soldering the pins 33 in the holes 23 in the printed circuit board 2.

The pins 33 of the shielding cage 3 and the holes 23 in the printed circuit board 2 firstly provide a fixed mechanical connection of the shielding cage 3 on the printed circuit board 2. What is more, the shielding cage 3 is preferably connected to a shielding potential of the arrangement via the pins 33. Furthermore, the shielding cage 3 is automatically oriented with regard to the contact-making region 21 of the printed circuit board 2 via the pins 33 and the holes 23. This ensures that after the module 1 has been introduced into the shielding cage 3, the contacts 140 of the plug base 14 of the module 1 are oriented to the contacts 210 of the first contact-making region 21 of the printed circuit board 2.

Moreover, on the top side of the printed circuit board 2, a metallization 22 is provided in the region of the shielding cage 3 or in the introduction region of the module 1, said metallization providing an electromagnetic shielding also toward the bottom. The holes 23 for the pins 33 are situated in the region of said metallization 22. The metallization 22 is, of course, not present in the contact-making region 21. Rather, the metallization 22 has a cutout there.

In addition to the pin 33 already mentioned, the shielding cage 3 has two spring mechanisms 31, 32. One spring mechanism 31 is formed on the top side of the shielding cage 3. Two springs projecting into the shielding cage are provided and exert a spring force directed perpendicular to the printed circuit board 2 on the plugged-in module 1. This ensures reliable contact of the electrical contacts 140, 210.

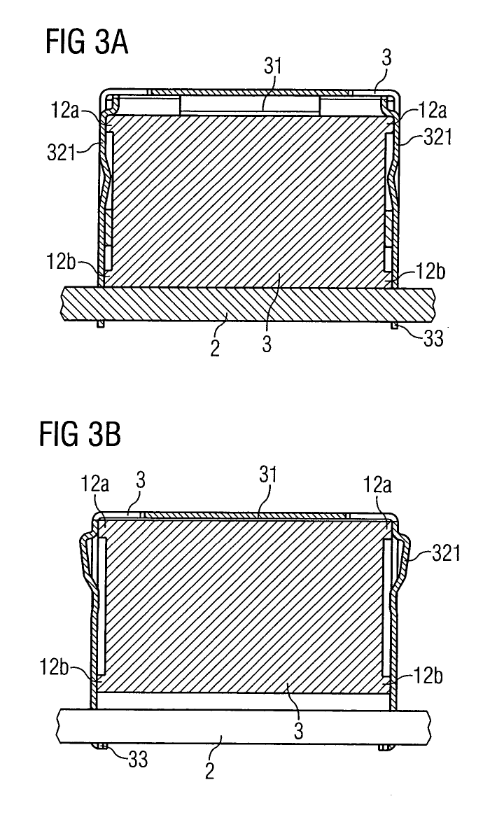

The other spring mechanism 32 provides a latching mechanism and is formed at the side wall of the shielding cage 3. As can be discerned in greater detail in FIGS. 3a, 3b, what are involved in each case are laterally deflectable spring brackets 321 which exert a spring force in the direction of the interior of the shielding cage 3.

The operation of plugging the module 1 into the shielding cage 3 that is fixedly mounted on the printed circuit board 2 will now be described, reference also being made, in particular, to FIGS. 3a, 3b.

When the module 1 is introduced into the shielding cage 3 the transverse bracket 111 is located toward the top (in contrast to the illustration in FIG. 1), with the result that the sub-arms 116, 118 project with respect to the underside 18 of the module housing. This ensures that, when the module 1 is introduced into the shielding cage 3, the plug base 14 does not drag on the printed circuit board 2 and is not thereby damaged.

The module 1 is introduced into the shielding cage 3 in the y direction, parallel to the printed circuit board 2. The module 2 is guided in the shielding cage 3 by means of the upper and lower guiding webs 12a, 12b. When the module 1 is introduced into the shielding cage 3, in this case, firstly, the lateral spring brackets 321 of the spring mechanism 32 are pressed outward by means of the upper guiding webs 12a. At the same time, the springs of the upper spring mechanism 31 are pressed upward by the top side 16 of the module housing. This situation is illustrated in sectional illustration in FIG. 3b.

After the module 1 has been completely introduced into the shielding cage 3, the positioning pins 13 on the underside 18 of the module are arranged opposite the openings 24 in the module board 2. The transverse bracket or lever 111 of the unlocking device 11 is then shifted over (into the position shown in FIG. 1). A plurality of operations proceed in parallel in this case.

Firstly, the positioning pins 13 are introduced into the openings 24 in the printed circuit board 2. If appropriate, in this case, as already explained, the pins 13 may be formed in conical fashion in order to facilitate introduction of the pins 13 into the openings 24. After the positioning pins 13 have been introduced in the openings 24, the module is fixed in the y direction.

Furthermore, when shifting over the lever 111 with the module 1, overall the upper guiding web 12a is also moved downward. This has the effect that the spring bracket 321 of the shielding cage 3 latch over the guiding webs 12a, for which purpose the latter are shaped correspondingly. This is illustrated in FIG. 3a. In this case, the spring brackets 321 prevent, through positively locking connection, the module 1 from moving away in the z direction, that is to say perpendicular to the printed circuit board 2. Such movement might be effected for example as a result of a tension on optical cables if optical plugs are plugged into the end side 15 of the module 1.

In this case, it is pointed out that a corresponding latching mechanism may equally be realized at the module housing 1.

With the lowering of the module 1 as a result of the transverse bracket 111 being shifted over, the spring 31 arranged at the top side of the shielding cage 3 also furthermore press into the interior of the cage 3 and provide for a permanent pressing of the module 1 downward onto the printed circuit board 2. This ensures electrical contact of the module 1.

An additional anchoring of the module 1 in the shielding cage 3 is effected—after the transverse bracket 111 has been shifted over—by the ends of the sub-arm 117, 119 that then protrude upward over the top side 16 of the module 1. These additionally support the module in the shielding cage 3.

The module 1 is then latched in the shielding cage 3, the electrical contacts of the printed circuit board and the electrical contacts of the module being in electrical contact. In this case, the module 1 is latched first of all by means of a movement exclusively in the y direction and then exclusively in the z direction.

It is pointed out that, after an optical plug has been introduced into the end side 15 of the module 1, the lever mechanism 111 cannot be operated. Consequently, it is then impossible to remove the module 1 from its shielding cage 3, in other words additional security is effected during operation.

In order to remove the module 1, plugs that are present, if appropriate, are first of all removed and then the transverse bracket 111 is shifted over (into the position illustrated in FIG. 1). As a result of this, the module is raised within the shielding cage in the z direction. In this case, the raising is effected counter to the spring force of the springs 31. At the same time, the ends of the spring brackets 321 are also directed outward. The module can then be removed in the y direction.

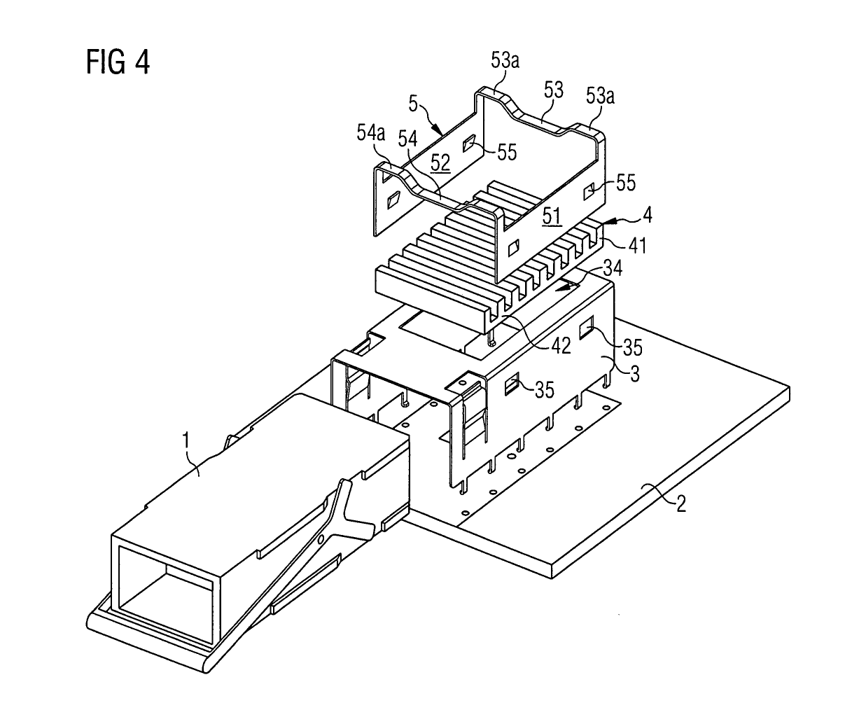

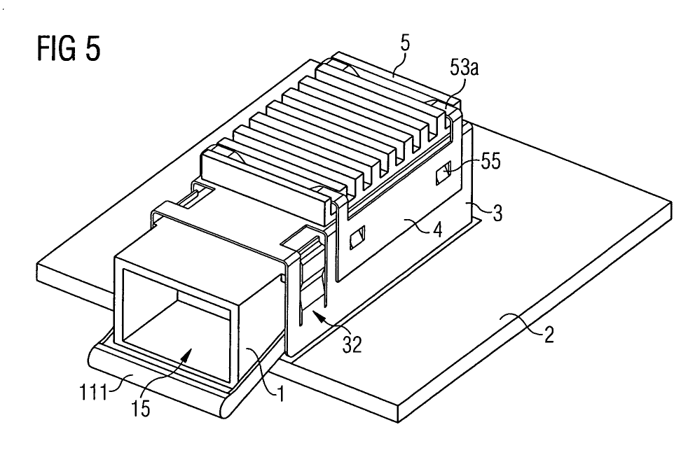

FIGS. 4 and 5 show an alternative exemplary embodiment, which differs from the exemplary embodiment of FIGS. 1 to 3b only in respect of the additional arrangement and fixing of a heat sink 4. Therefore, this further exemplary embodiment will be discussed only insofar as different structures and functions are present. For the rest, the functioning is exactly as in the case of the arrangement of FIGS. 1 to 3b.

The heat sink 4 has a baseplate 42, on which a plurality of ribs 41 running parallel to one another are formed. Such heat sinks are known per se and so they are not discussed any further.

In this configuration, the shielding cage 3 has a cutout 34 at its top side, through which cutout the heat sink 4 projects into the interior of the shielding cage. In this case, after the introduction of the module 1, the baseplate 42 rests on the top side 16 of the module 1 in a large-area manner, with the result that heat produced in the module 1 can be effectively transported away.

In order to fix the heat sink 4 to the shielding cage 3, a spring mechanism 5 is provided, having two side parts 51, 52 which run parallel and are connected to one another by two spring arms 53, 54 formed in resilient fashion. In this case, a spring force is provided by means of bent nipples 53a, 54a of the spring brackets 53, 54. Inwardly projecting holding springs 55 are formed at the side parts 51, 52, which holding springs correspond with matching cutouts 35 in the side walls of the shielding plate 3.

In the assembled state of FIG. 5, the spring mechanism 5 is fixedly connected to the shielding plate 3 by means of the holding springs 55. The spring arms 53 and 54 exert a force on the heat sink 4 and press the latter against the top side of the module 1. At the same time, on account of their being fixed to the shielding housing 3, which is in turn fixed to the printed circuit board 2, the spring arms 53, 54 also press the module 1 overall against the printed circuit board 2 and thus ensure that electrical contact is reliably made with the respective electrical contacts. The spring mechanism 5 thus provides a dual function: on the one hand, it presses the heat sink 4 against the module 1 and, on the other hand, it presses the module 1 against the printed circuit board 2. This ensures electrical contact of the module.

FIG. 5 reveals that a front part of the module 1 projects from the shielding cage 3 in the latched state. This part preferably projects from a back plane of a computer housing, for example. In this way, optical plugs can easily be plugged into and unplugged from the optical port of the module 1 provided by the end side 15. The module 1 overall can also be plugged in and unplugged through a corresponding opening in a back plane from outside and after the mounting of the remaining parts.

The configuration of the invention is not restricted to the exemplary embodiments presented above. By way of example, it is not necessary for the shielding housing 3 to provide electromagnetic shielding of the module. Instead of a shielding housing 3, an arbitrary other receptacle structure having a receptacle opening for receiving an optical module may also be provided.

1. An optoelectronic arrangement comprising:
a printed circuit board, which defines a first direction parallel to a printed circuit board surface and a second direction perpendicular to the printed circuit board surface,
a first electrical contact-making region of the printed circuit board with a plurality of first contacts,
a receptacle structure arranged on the printed circuit board and having a receptacle opening for receiving a pluggable optoelectronic module,
a pluggable optoelectronic module,
a second electrical contact-making region of the optoelectronic module with a plurality of second contacts, and
plug-in means for plugging the optoelectronic module into the receptacle structure in such a way that, during the plug-in operation, the module is firstly introduced into the receptacle structure in the first direction and is then lowered in the second direction in the direction of the printed circuit board,
wherein the second contacts of the optoelectronic module are in electrical contact with the first contacts of the printed circuit board in the plugged-in position.

2. The arrangement according to claim 1, wherein the plug-in means comprises a locking/unlocking mechanism formed on the module, by means of which mechanism the module is raised or lowered in the second direction.

3. The arrangement according to claim 1, wherein the module comprises a module housing with an end side, a rear side, a top side, an underside and two side walls, and configured to receive at least one optical plug into the module via the end side.

4. The arrangement according to claim 2, wherein the locking/unlocking mechanism comprises a lever configured to move between two end positions at the end side of the module, the module being in a locked state with respect to the printed circuit board in one end position of the lever.

5. The arrangement according to claim 4, wherein the locking/unlocking mechanism further comprises two arms acting as a lever, which are mounted in rotatable fashion at opposite side walls of the module housing in each case at a bearing location.

6. The arrangement according to claim 5, wherein the arms, on the other side of the bearing location opposite the end side, in each case are configured to form at least two end regions at a different distance from the bearing location, wherein one of said arm end regions contacts the printed circuit board or the receptacle structure in one end position of the lever and the other of said arm end regions contacts the printed circuit board or the receptacle structure in the other end position of the lever.

7. The arrangement according to claim 6, wherein the arms each branch at their ends in Y-shaped fashion to form two sub-arms in such a way that one sub-arm is in contact with the printed circuit board or the receptacle structure in the one end position of the lever and the other sub-arm is in contact with the printed circuit board or the receptacle structure in the other end position of the lever.

8. The arrangement according to claim 2, wherein the locking/unlocking mechanism comprises elements which protrude from at least one outer area of the module housing in the locked state of the module.

9. The arrangement according to claim 1, wherein the plug-in means comprises guiding means which provide a guiding of the module in the receptacle structure during the movement of the module in the first direction.

10. The arrangement according to claim 1, further comprising spring means configured to press the plug-in module onto the printed circuit board with a spring force directed perpendicular to said printed circuit board surface.

11. The arrangement according to claim 10, wherein the spring means resides on the receptacle structure.

12. The arrangement according to claim 1, for the positioning of the module in the first direction, the module comprising first positively locking elements and the printed circuit board comprising second positively locking elements, wherein the first and second positively locking elements intermesh when the module is plugged in.

13. The arrangement according to claim 12, the first positively locking elements of the module comprising at least two projecting pins and the second positively locking elements of the printed circuit board comprising correspondingly arranged holes.

14. The arrangement according to claim 1, further comprising a latching mechanism configured to impede the module in the plugged-in position from moving in the second direction away from the printed circuit board surface.

15. The arrangement according to claim 14, wherein the latching mechanism comprises spring elements which latch with structures of the module during the plug-in operation after the lowering of the module in the second direction.

16. The arrangement according to claim 14, wherein the locking/unlocking mechanism is configured to deactivate the latching mechanism when the module is raised in the second direction.

17. The arrangement according to claim 1, wherein the second contacts of the module and the first contacts of the printed circuit board in each case are arranged in the form of a two-dimensional matrix.

18. The arrangement according to claim 3, wherein the second electrical contact-making region of the optoelectronic module with the plurality of second contacts is formed by a plug base arranged on the underside of the module housing.

19. The arrangement according to claim 18, wherein the second contacts arranged at the plug base are formed in an elastically deformable fashion.

20. The arrangement according to claim 1, wherein some of the second contacts are formed in a mechanically leading fashion, in such a way that a defined electrical contact-making order is provided during the plugging-in and during the removal of the module.

21. The arrangement according to claim 1, wherein the first electrical contact-making region of the printed circuit board is formed directly on the surface of the printed circuit board, and the first contacts are formed by metallizations directly on the surface of the printed circuit board.

22. The arrangement according to claim 1, further comprising a heat sink configured to project into the receptacle structure via an opening at the top side of the receptacle structure and make large-area mechanical contact with the module in the plugged-in position.

23. The arrangement according to claim 22, further comprising a spring means configured to press the heat sink against the plugged-in module with a spring force.

24. The arrangement according to claim 23, wherein the spring means is supported at the receptacle structure and correspondingly additionally presses, in the plugged-in position of the module, the second electrical contact-making region of the module against the first electrical contact-making region of the printed circuit board.

25. The arrangement according to claim 24, wherein the spring means comprises two side parts running parallel to one another and respectively connected to one side of the receptacle structure, and wherein the spring means further comprises at least two spring arms that are formed in resilient fashion and connect the side parts together, wherein the spring arms partly rest on the heat sink and exert a spring force on the heat sink in the second direction.

26. The arrangement according to claim 1, wherein the receptacle structure comprises a shielding cage comprising an electrically conductive material.

27. The arrangement according to claim 26, wherein the shielding cage comprises at its underside a plurality of protruding pins via which the shielding cage is mechanically fixedly connected to the printed circuit board.

28. The arrangement according to claim 27, wherein the shielding cage is electrically connected to a shielding potential of the arrangement via the protruding pins.

29. The arrangement according to claim 26, wherein the printed circuit board comprises a metallization on the printed circuit board surface in the region covered by the shielding cage and, having a cut-out portion therein corresponding to the first electrical contact-making region, at its top side.

30. The arrangement according to claim 1, wherein the module as comprises a parallel optoelectronic module via which data can be emitted or received in parallel on a plurality of optical channels.
